(19) United States
(12) Patent Application Publication
(10) Pub. No.: US 2024/0246563 A1
(43) Pub. Date: Jul. 25, 2024

(54) ROUTE DECIDING METHOD, SYSTEM AND DEVICE, AND MEDIUM

(71) Applicant: GUANGZHOU WERIDE TECHNOLOGY LIMITED COMPANY, Guangzhou, Guangdong (CN)

(72) Inventors: Sisi LI, Guangzhou, Guangdong (CN); Zeyin ZHANG, Guangzhou, Guangdong (CN)

(73) Assignee: GUANGZHOU WERIDE TECHNOLOGY LIMITED COMPANY, Guangzhou, Guangdong (CN)

(21) Appl. No.: 18/560,390

(22) PCT Filed: Sep. 20, 2022
(86) PCT No.: PCT/CN2022/119830

§ 371 Date: Nov. 12, 2023

(30) Foreign Application Priority Data
Sep. 29, 2021 (CN) 202111155395.9
Nov. 30, 2021 (CN) 202111453193.2

(51) Int. Cl. B60W 60/00; B60W 30/18; G01C 21/34

(52) U.S. Cl. CPC B60W 60/001; B60W 30/18163; G01C 21/3446; B60W 2520/10; B60W 2554/20; B60W 2554/40; B60W 2554/802; B60W 2556/20

(57) ABSTRACT

A route deciding method, system, and device, and a medium. The method comprises: dividing the drivable road between the current position of a driverless vehicle and a destination into a plurality of waypoints; determining a target waypoint from among the waypoints between the current position of the driverless vehicle and the destination, and calculating the global cost from the target waypoint to the destination so as to obtain the waypoint value of the target waypoint; iteratively calculating the waypoint values of the waypoints between the target waypoint and the current position of the driverless vehicle according to the waypoint value of the target waypoint; and determining in real time the action at the current position according to the waypoint value of the next waypoint corresponding to the current position of the driverless vehicle so as to obtain the current route decision result on driving to the destination. The present invention improves the technical problem in existing techniques of low route decision efficiency due to model predictive control being used and complex optimization problems being solved in order to obtain the optimal route decision, and a large amount of computing power being necessary to solve non-linear optimization problems.

### CROSS REFERENCE OF RELATED APPLICATION

This application claims priority to Chinese Patent Application No. 202111155395.9, titled “METHOD, SYSTEM, DEVICE FOR LANE CHANGE STRATEGY OF DRIVERLESS VEHICLE AND MEDIUM”, filed on Sep. 29, 2021, and Chinese Patent Application No. 202111453193.2, titled “ROUTE DECIDING METHOD, SYSTEM AND DEVICE, AND MEDIUM”, filed on Nov. 30, 2021 with the China National Intellectual Property Administration, both of which are hereby incorporated by reference in their entireties.

### FIELD

The present disclosure relates to the field of driverless vehicles technology, and more particularly, to a route decision method, system, device and medium.

### BACKGROUND

A driverless vehicle is a comprehensive intelligent platform that integrates multiple functions such as environmental perception and cognition, dynamic planning and deciding, behavioral control and execution. The key issues of driverless vehicle research include environmental perception, behavioral deciding and motion control.

Lane decision is a main component of driverless vehicle decision technology. In conventional technology, a model predictive control method is usually used to obtain an optimal route decision. In a process of obtaining the optimal route decision by solving complex optimization problems, a large amount of computing power is required to solve nonlinear optimization problems, resulting in low route decision efficiency. Thus, the optimal route decision is difficult to be effectively applied to the decision system of driverless vehicles.

### SUMMARY

A route decision method, system, equipment and medium are provided according to the present disclosure, to improve the technical problems that in the conventional technology, a model predictive control method is used to obtain an optimal route decision, and a process of obtaining the optimal route decision by solving complex optimization problems requires a large amount of computing power to solve nonlinear optimization problems, which results in low route decision efficiency.

In view of this, a route decision method is provided according to a first aspect of the present disclosure. The method includes:
dividing a drivable road between a current position of a driverless vehicle and a destination into a plurality of waypoints, wherein the drivable road includes at least one lane, and the lane includes waypoints connected in sequence;
determining a target waypoint among the waypoints between the current position of the driverless vehicle and the destination, and calculating a global cost from the target waypoint to the destination to obtain a waypoint value of the target waypoint;
performing an iteration to calculate a waypoint value of a waypoint between the target waypoint and the current position of the driverless vehicle, according to the waypoint value of the target waypoint; and
determining an action of the driverless vehicle at the current position based on a waypoint value of a next waypoint corresponding to the current position of the driverless vehicle in real time, and obtaining a current route decision result for driving to the destination.

In an embodiment, the calculating the global cost from the target waypoint to the destination to obtain the waypoint value of the target waypoint includes:
obtaining a shortest path from the target waypoint to the destination in a graph search algorithm;
calculating a driving time of the driverless vehicle from the target waypoint to the destination based on the shortest path and a preset driving speed;
obtaining the global cost from the target waypoint to the destination based on the driving time of the driverless vehicle from the target waypoint to the destination; and
utilizing the global cost from the target waypoint to the destination as the waypoint value of the target waypoint.

In an embodiment, the obtaining the global cost from the target waypoint to the destination based on the driving time of the driverless vehicle from the target waypoint to the destination includes:
utilizing the driving time of the driverless vehicle from the target waypoint to the destination as the global cost from the target waypoint to the destination; or
calculating the global cost from the target waypoint to the destination based on target information from the target waypoint to the destination and the driving time of the driverless vehicle from the target waypoint to the destination.

In an embodiment, the performing the iteration to calculate the waypoint value of the waypoint between the target waypoint and the current position of the driverless vehicle based on the waypoint value of the target waypoint includes:
calculating a waypoint value of a previous waypoint corresponding to the target waypoint by:
calculating a short-term cost and a state transition probability of transferring from the previous waypoint corresponding to the target waypoint to the target waypoint; and
superimposing the short-term cost of transferring from the previous waypoint corresponding to the target waypoint to the target waypoint, with the waypoint value of the target waypoint; and calculating the waypoint value of the previous waypoint corresponding to the target waypoint by combining a value of the short-term cost superimposing with the waypoint value of the target waypoint and the state transition probability.

In an embodiment, a plurality of target waypoints is provided between the current position of the driverless vehicle and the destination.

In an embodiment, the method further includes:
obtaining a special waypoint affected by traffic information when the driverless vehicle is driven according to the current route decision result;
in a case that the special waypoint is to be reached according to the current route decision result, determining a next waypoint of the special waypoint according to the current route decision result, and updating a short-term cost from the special waypoint to the next waypoint;
updating a waypoint value of the special waypoint, based on the updated short-term cost from the special waypoint to the next waypoint;
performing a reverse iteration to update a waypoint value of a waypoint between the special waypoint and the current position of the driverless vehicle, according to the updated waypoint value of the special waypoint; and returning to the step of determining the action of the driverless vehicle at the current position based on the waypoint value of the next waypoint corresponding to the current position of the driverless vehicle in real time and obtaining the current route decision result for driving to the destination.

In an embodiment, in a case that the traffic information includes a static traffic participant, the obtaining the special waypoint affected by traffic information when the driverless vehicle is driving according to the current route decision result includes:
determining the special waypoint affected by the static traffic participant based on a position of the static traffic participant when the driverless vehicle is driving according to the current route decision result.

In an embodiment, the method further includes:
in a case that the special waypoint affected by the static traffic participant is a waypoint to be reached according to the current route decision result and an adjacent lane of a lane where the special waypoint is located is impassable, dividing a lane line between the lane where the special waypoint affected by the static traffic participant is located and the adjacent lane into a plurality of waypoints connected in sequence; and
calculating the waypoint value of each waypoint on the lane line based on waypoint values of waypoints on the lanes adjacent to the lane line, the short-term cost and state transition probability of transferring between waypoints, and returning to the step of determining the action of the driverless vehicle at the current position based on the waypoint value of the next waypoint corresponding to the current position of the driverless vehicle in real time, and obtaining the current route decision result for driving to the destination.

In an embodiment, when the traffic information includes dynamic traffic participants, the obtaining the special waypoint affected by traffic information when the driverless vehicle is driving according to the current route decision result includes:
determining a target dynamic traffic participant from the dynamic traffic participants when the driverless vehicle is driving according to the current route decision result; and
determining a special waypoint affected by the target dynamic traffic participant based on a driving speed of the target dynamic traffic participant and a driving speed of the driverless vehicle.

In an embodiment, determining the target dynamic traffic participant from the dynamic traffic participants includes:
determining a dynamic traffic participant within a preset range in front of the driverless vehicle as a potential target dynamic traffic participant;
determining whether a driving speed of the potential target dynamic traffic participant is less than a speed limit value of a lane where the potential target dynamic traffic participant is located, and obtaining a determination result;
calculating a confidence of the potential target dynamic traffic participant according to a value of the potential target dynamic traffic participant and the determination result; and
determining the target dynamic traffic participant from the potential target dynamic traffic participant based on the confidence.

In an embodiment, in the case that the special waypoint is to be reached according to the current route decision result, the determining the next waypoint of the special waypoint according to the current route decision result and updating a short-term cost from the special waypoint to the next waypoint includes:
in the case that the special waypoint is to be reached according to the current route decision result, determining the next waypoint of the special waypoint according to the current route decision result, and determining a driving distance from the special waypoint to the next waypoint; and
calculating the short-term cost of the driverless vehicle from the special waypoint to the next waypoint based on the driving distance and the driving speed of the target traffic participant, and obtaining the updated short-term cost from the special waypoint to the next waypoint.

In an embodiment, the state transition probability includes a lane change success rate, and the method further includes: updating the lane change success rate of transferring between waypoints within the preset range of the driverless vehicle, based on the traffic information.

In an embodiment, the updating the lane change success rate of transferring between waypoints within the preset range of the driverless vehicle based on the traffic information includes:
obtaining a current distance between a rear side vehicle of the driverless vehicle and the driverless vehicle and a current giving-way probability of the rear side vehicle of the driverless vehicle according to the traffic information, and updating the lane change success rate of the driverless vehicle at a current waypoint; and
updating a lane change success rate of a remaining waypoint within the preset range of the driverless vehicle according to a traffic density of a target change lane, wherein the target change lane is a lane after lane changing, and the remaining waypoint within the preset range of the driverless vehicle is a waypoint within the preset range of the driverless vehicle except the current waypoint where the driverless vehicle is located.

In an embodiment, the current giving-way probability of the rear side vehicle of the driverless vehicle is calculated by:
calculating the current giving-way probability of the rear side vehicle according to a current acceleration of the rear side vehicle of the driverless vehicle and a giving-way probability of the rear side vehicle at a previous moment, wherein an initial giving-way probability of the rear side vehicle is obtained through initialization.

A route decision system is provided according to a second aspect of the present disclosure. The route decision system includes: a dividing module, a first calculation module, a second calculation module and a deciding module.

The dividing module is configured to divide a drivable road between a current position of a driverless vehicle and a destination into a plurality of waypoints, wherein the drivable road includes at least one lane, and the lane includes waypoints connected in sequence.

The first calculation module is configured to determine a target waypoint among the waypoints between the current position of the driverless vehicle and the destination, and calculate a global cost from the target waypoint to the destination to obtain a waypoint value of the target waypoint.

The second calculation module is configured to performing an iteration to calculate a waypoint value of a waypoint between the target waypoint and the current position of the driverless vehicle according to the waypoint value of the target waypoint.

The deciding module is configured to determine an action at the current position according to a waypoint value of a next waypoint corresponding to the current position of the driverless vehicle in real time, and obtain a current route decision result for driving to the destination.

A route decision device is provided according to a third aspect of the present disclosure. The device includes a processor and a memory.

The memory is configured to store program codes and transmit the program codes to the processor.

The processor is configured to execute instructions in the program codes to implement any one of the route decision methods described in the first aspect.

A computer-readable storage medium is provided according to a fourth aspect of the present disclosure. The computer-readable storage medium is configured to store program codes, and the program codes, when executed by the processor, cause to processor to implement any one of the route decision methods described in the first aspect.

Based on the above technical solutions, the present disclosure has following advantages.

The route decision method according to the present disclosure includes: dividing a drivable road between a current position of a driverless vehicle and a destination into multiple waypoints, wherein the drivable road includes at least one lane, and each lane includes multiple waypoints connected in sequence; determining a target waypoint among the waypoints between the current position of the driverless vehicle and the destination, and calculating a global cost from the target waypoint to the destination to obtain a waypoint value of the target waypoint; performing an iteration to calculate a waypoint value of a waypoint between the target waypoint and the current position of the driverless vehicle according to the waypoint value of the target waypoint; and determining an action at the current position based on a waypoint value of a next waypoint corresponding to the current position of the driverless vehicle in real time, and obtaining a current route decision result for driving to the destination. The action includes turning left, staying in a current lane, or turning right.

In the present disclosure, the drivable road between the driverless vehicle and the destination is divided into multiple waypoints. By calculating the waypoint value of each waypoint, the driverless vehicle can make route decision at each waypoint according to the waypoint value of the next waypoint, which simplifies a complex route decision optimization problem and calculates waypoint values in two stages. In a first stage, the global cost from the target waypoint to the destination is calculated, and the waypoint value of the target waypoint is obtained. In a second stage, a reverse iteration is performed to calculate the waypoint value of the waypoint between the target waypoint and the current position of the driverless vehicle, according to the waypoint value of the target waypoint. Thus, the calculation speed of the waypoint value and the route decision efficiency are improved, improving the technical problems that in the conventional technology a model predictive control method is used to obtain an optimal route decision and a process of obtaining the optimal route decision by solving complex optimization problems requires a large amount of computing power to solve nonlinear optimization problems, which results in a low route decision efficiency.

### BRIEF DESCRIPTION OF THE DRAWINGS

In order to more clearly illustrate the technical solutions in the embodiments of the present disclosure or the conventional technology, the drawings that need to be used in the description of the embodiments or the conventional technology can be briefly introduced. Obviously, the drawings in the following description are only some embodiments of the present disclosure. Those skilled in the art can also obtain other drawings based on these drawings without any creative effort.

FIG. 1 is a schematic flow chart of a route decision method according to an embodiment of the present disclosure;

FIG. 2 is a hub point distribution diagram according to an embodiment of the present disclosure;

FIG. 3 is a waypoint distribution diagram according to an embodiment of the present disclosure;

FIG. 4 is a distribution diagram of waypoint values of each waypoint in FIG. 3 which is calculated from static traffic information according to an embodiment of the present disclosure;

FIG. 5 is a traffic scene with static traffic participants according to an embodiment of the present disclosure;

FIG. 6 is an updated waypoint value distribution diagram of each waypoint value in FIG. 5 according to an embodiment of the present disclosure;

FIG. 7 is a traffic scene with dynamic traffic participants according to an embodiment of the present disclosure;

FIG. 8 is a distribution diagram of waypoint values before updating in the case that there are dynamic traffic participants according to an embodiment of the present disclosure;

FIG. 9 is a distribution diagram of the waypoint values in FIG. 8 after updating according to an embodiment of the present disclosure;

FIG. 10 is a distribution diagram of waypoint values in a special traffic scenario according to an embodiment of the present disclosure; and

FIG. 11 is a schematic structural diagram of a route decision system according to an embodiment of the present disclosure.

### DETAILED DESCRIPTION

The present disclosure provides a route decision method, system, equipment and medium to improve the technical problems that in the conventional technology, a model predictive control method is used to obtain an optimal route decision, and a process of obtaining the optimal route decision by solving complex optimization problems requires a large amount of computing power to solve nonlinear optimization problems, which results in low route decision efficiency.

In order to enable those skilled in the art to better understand the solution of the present disclosure, the technical solution in the embodiment of the present disclosure will be clearly and completely described below in conjunction with the drawings in the embodiment of the present disclosure. Obviously, the described embodiment is only a part of the embodiments of the present disclosure, not all of them. Based on the embodiments in the present disclosure, all other embodiments obtained by those skilled in the art without making creative efforts belong to the scope of protection of the present disclosure.

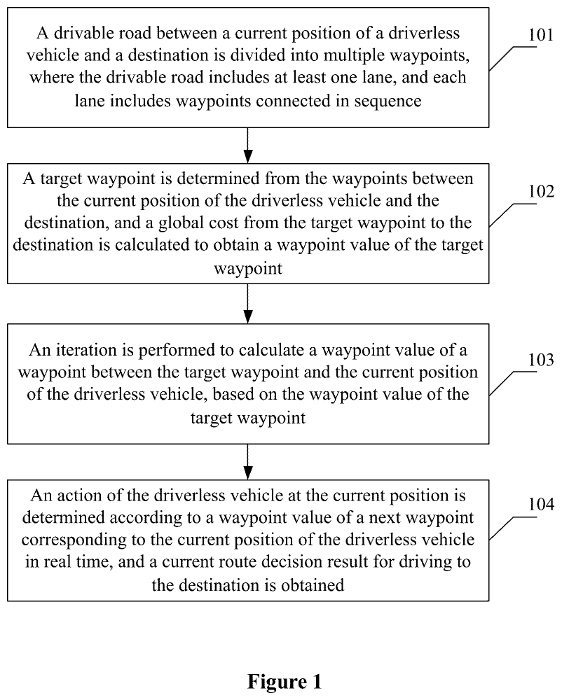

For ease of understanding, referring to FIG. 1, a route decision method is provided according to an embodiment of the present disclosure. The route decision method includes steps 101 to 104 as follows.

In step 101, a drivable road between a current position of a driverless vehicle and a destination is divided into multiple waypoints, where the drivable road includes at least one lane, and each lane includes waypoints connected in sequence.

After the destination is determined, the drivable road between the current position of the driverless vehicle and the destination is divided into multiple waypoints. The drivable road includes at least one lane, and each lane includes multiple waypoints connected in sequence. The waypoints on each lane are evenly distributed. The driverless vehicle makes route decision at each waypoint to determine whether to change lane and how to change lane.

In step 102, a target waypoint is determined from the waypoints between the current position of the driverless vehicle and the destination, and a global cost from the target waypoint to the destination is calculated to obtain a waypoint value of the target waypoint

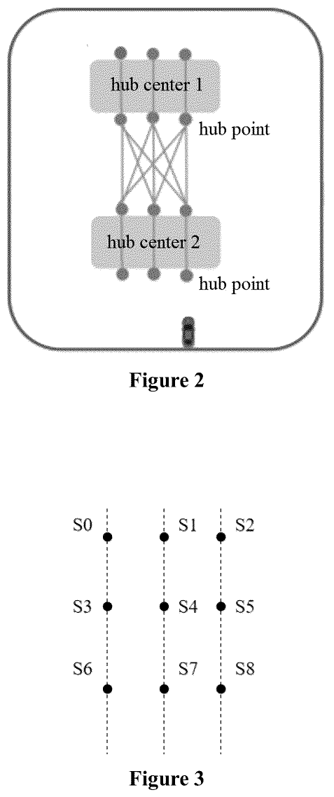

At least one target waypoint can be determined from the waypoints between the current position of the driverless vehicle and the destination. When an intersection (including a crossroad, a T-junction, and the like) is between the current position of the driverless vehicle and the destination, the intersection of the drivable road between the current position of the driverless vehicle and the destination is set as a hub center, and a connection point of each road and each hub center are set as a hub point. The connection point includes an entry point and an exit point of the hub center. Referring to FIG. 2 for details, connection lines between hub points is movement modes of the driverless vehicle between the hub points. For example, the driverless vehicle can reach another hub point from a current hub point by changing lane, but driverless vehicles cannot change lane in the hub center. The connection relationship between the hub points needs to consider a global map and traffic rules. After the hub center is determined, a waypoint corresponding to an entry point of a certain hub center (which may be a hub center closest to the driverless vehicle, such as Hub center 1 in FIG. 2) can be chosen as the target waypoint. Alternatively, the waypoints corresponding to the entry points of multiple hub centers are chosen as the target waypoints. It should be understood that other waypoint may also be selected as the target waypoint, which is not specifically limited herein.

After the target waypoint is determined, a global cost from the target waypoint to the destination is calculated to obtain the waypoint value of the target waypoint. The specific calculation process of the waypoint value of the target waypoint can be as follows.

The shortest path from the target waypoint to the destination is obtained in graph search algorithm. A driving time of the driverless vehicle from the target waypoint to the destination is calculated based on the shortest path and a preset driving speed. The global cost from the target waypoint to the destination is obtained based on the driving time of the driverless vehicle from the target waypoint to the destination. The global cost from the target waypoint to the destination is used as the waypoint value of the target waypoint.

Specifically, a global map of the driverless vehicle to the destination can be obtained, and then the global map may be analyzed in graph search algorithm (such as A-star algorithm) to obtain the shortest path from the target waypoint to the destination. The driving time of the driverless vehicle from the target waypoint to the destination is calculated based on the shortest path from the target waypoint to the destination and the preset driving speed. The preset driving speed may be a speed limit value of the lane. Finally, the global cost from the target waypoint to the destination is obtained based on the driving time from the target waypoint to the destination, and the global cost from the target waypoint to the destination is used as the waypoint value of the target waypoint.

It should be noted that when the target waypoint is the entry point of the hub center, the global map can be converted into a search map composed of hub points; when the target waypoint is not the entry point of the hub center, the global map can be converted into a search map composed of waypoints. Then, the search map is analyzed in graph search algorithm to obtain the shortest path from the target waypoint to the destination.

In an embodiment, the driving time of the driverless vehicle from the target waypoint to the destination can be used as the global cost from the target waypoint to the destination. When the target waypoint is the entry point of the certain hub center, there are multiple target waypoints. After the global cost from each target waypoint to the destination is calculated, the driverless vehicle can determine which target waypoint can reach the destination fastest when entering the hub center through the global cost.

In an embodiment, the global cost from the target waypoint to the destination can be calculated according to target information from the target waypoint to the destination and the driving time of the driverless vehicle from the target waypoint to the destination. The global cost from the target waypoint to the destination can be determined by multiple factors, for example, a distance between the target waypoint and the destination, the number of traffic lights between the target waypoint and the destination, whether there is a toll station, and the like. Therefore, the global cost can be calculated based on the driving time by considering the number information of the traffic lights or toll station information. Specifically, the driving time and target information are comprehensively considered. The target information in the embodiment of the present disclosure includes information on the number of traffic lights or toll station information. The target information may further include other information related to driving requirement. The global cost can be obtained by assigning weights to the driving time and the target information and linearly combining the weighted driving time and the weighted target information. A specific weight assignment can be set according to an actual situation, which is not specifically limited here.

It can be understood that the global cost of the target waypoint depends on a position of the destination input by a user. When the user does not update the destination, the global cost of the target waypoint is fixed.

In step 103, iteration is performed to calculate a waypoint value of a waypoint between the target waypoint and the current position of the driverless vehicle, based on the waypoint value of the target waypoint.

In an embodiment of the present disclosure, a selection process of the waypoint is modeled as Markov decision model, and the waypoint is a state that the driverless vehicle can be in. The Markov decision model can be expressed as <S, A, T, C>, where S is a state space of the driverless vehicle; A={change lane to left, maintain lane, change lane to right} is an action set of the driverless vehicle; C is a single-step cost function used to calculate a short-term cost of the driverless vehicle for transferring from one state to another state, for example, C(s,a,s′) is used to calculate the short-term cost which is required to transfer the driverless vehicle from the waypoint s to the waypoint s′ by the action a; T is a transfer model, which represents an uncertainty caused by the action, for example, T(s, change lane to right, s′) represents a lane change success rate of the driverless vehicle which changes the lane to right from the waypoint s to the waypoint s′.

In an embodiment of the present disclosure, when the waypoint value of the waypoint between the target waypoint and the current position of the driverless vehicle is iteratively calculated according to the waypoint value of the target waypoint, only static traffic information is considered. It is assumed that the driverless vehicle drives in a static and time-invariant traffic environment, only the ego vehicle but no other traffic participant is between the current position of the driverless vehicle and the destination. A process of calculating a waypoint value of a previous waypoint corresponding to the target waypoint can be as follows:

In S1031, the short-term cost and state transition probability of transferring from the previous waypoint corresponding to the target waypoint to the target waypoint are calculated.

After the waypoint value of the target waypoint is calculated, a reverse iteration is performed to calculate the waypoint value of the previous waypoint corresponding to the target waypoint. The driverless vehicle needs to pay a certain cost when transferring between waypoints. The short-term cost of transferring between waypoints can be calculated through a single-step cost function C, and the state transition probability of transferring between waypoints is determined through a transfer model T. The driving time for transferring from the previous waypoint corresponding to the target waypoint to the target waypoint by changing the lane to left, maintaining the lane, or changing the lane to right is calculated, according to a distance between the previous waypoint corresponding to the target waypoint and the target waypoint, and the speed limit value or the average historical driving speed of the lane where the target waypoint is located. It should be noted that the previous waypoint corresponding to the target waypoint includes multiple waypoints. If the target waypoint is located in a middle lane of three lanes, the previous waypoint corresponding to the target waypoint includes a previous waypoint of a left lane, a previous waypoint of the current lane and a previous waypoint of the right lane. If the target waypoint is located in the left lane of the three lanes, the previous waypoint corresponding to the target waypoint includes the previous waypoint of the current lane and the previous waypoint of the middle lane.

In an embodiment, the driving time from the previous waypoint corresponding to the target waypoint to the target waypoint can be directly used as the short-term cost of transferring from the previous waypoint corresponding to the target waypoint to the target waypoint.

In another embodiment, other losses can be considered based on the calculated driving time from the previous waypoint corresponding to the target waypoint to the target waypoint. For example, user preference setting that prevent driverless vehicle from driving in the rightmost lane or from entering a bus lane may cause certain losses. Therefore, the short-term cost from the previous waypoint corresponding to the target waypoint to the target waypoint may be obtained, by adding the loss generated by the user preference setting based on the driving time from the previous waypoint corresponding to the target waypoint to the target waypoint.

In S1032, the short-term cost of transferring from the previous waypoint corresponding to the target waypoint to the target waypoint is superimposed with the waypoint value of the target waypoint, and the waypoint value of the previous waypoint corresponding to the target waypoint is calculated by combining a value of the short-term cost superimposing with the waypoint value of the target waypoint and the state transition probability.

When the reverse iteration is performed to calculate the waypoint value of the waypoint between the target waypoint and the current position of the driverless vehicle, the short-term cost of transferring from the previous waypoint corresponding to the target waypoint to the target waypoint is superimposed on the waypoint value of the target waypoint, and the waypoint value of the previous waypoint corresponding to the target waypoint is calculated based on the state transition probability. In the case of multiple previous waypoints of the target waypoint, different actions are performed to transferring from different previous waypoints to the target waypoint. As shown in FIG. 3, the previous waypoint of the target waypoint S0 in the current lane (i.e., the left lane) is S3, and the previous waypoint of the target waypoint S0 in the adjacent lane (i.e., the middle lane) is S4. The previous waypoint of the target waypoint S1 in the current lane (i.e., the middle lane) is S4, and the previous waypoints in the adjacent lanes (the left lane and the right lane) are S3 and S5. The previous waypoint of target waypoint S2 in the current lane (i.e., the right lane) is S5, and the previous waypoint of target waypoint S2 in adjacent lane (i.e., the middle lane) is S4.

It is assumed that the waypoint values of target waypoints S0, S1 and S2 are 100, 50 and 80 respectively, and the single-step cost function is set to C(s,a,s′)=1. That is, the driverless vehicle only needs to pay a cost in 1 unit to transfer between waypoints. The lane change success rate is set to 20%. That is, when the driverless vehicle changes the lane at each waypoint, there is a 20% chance of successful lane change.

In a process of calculating the waypoint value of the previous waypoint S4 corresponding to the target waypoint, the actions which can be performed by the driverless vehicle at the waypoint S4 include: changing the lane to left, maintaining the lane, and changing the lane to right. When the maintaining the lane is chosen to transfer from waypoint S4 to the target waypoint S1, the waypoint value of the waypoint S4 is V(S4) maintain lane=(50+1)*100%=51.

When the changing the lane to left is chosen to transfer from the waypoint S4 to the target waypoint S0, due to 20% lane change success rate, the waypoint value of the waypoint S4 is V(S4)_{change lane to left}=(100+1)*20%+(50+1)*80%=71.

When the changing the lane to right is chosen transfer from the waypoint S4 to the target waypoint S2, due to 20% lane change success rate, the waypoint value of the waypoint S4 is V(S4)_{change the lane to right}=(80+1)*20%+(50+1)*80%=57.

Lastly, V(S4)=min(V(S4)_{maintain lane}, V(S4)_{change the lane to left}, V(S4) change the lane to right)=51, and thus the waypoint value of the waypoint S4 is 51 finally.

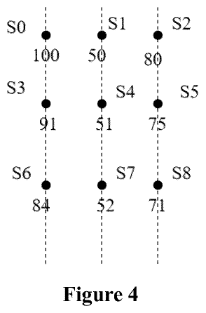

The action of the driverless vehicle performable at waypoint S3 include: maintaining the lane and changing the lane to right. The waypoint value of waypoint S3 is V(S3)=min(V(S3)_{maintain lane}, V(S3)_{change the lane to right}). The action performable at waypoint S5 includes changing the lane to left and maintaining the lane. The waypoint value of waypoint S5 is V(S5)=min(V(S5)_{maintain lane}, V(S5)_{change the lane to left}). The waypoint values of waypoint S3 and waypoint S5 are calculated finally, as shown in FIG. 4.

The process of calculating the waypoint value of each waypoint between the target waypoint and the current position of the driverless vehicle can be summarized as:

$$V ( s ) = {min}_{a ∈ A} {E}_{T} [ C ( s , a , {s}^{′} ) + V ( {s}^{′} ) ] .$$

In the above formula, v (s) is the waypoint value of the waypoint s, C (s, a, s′) is the short-term cost of the driverless vehicle from the waypoint s to reach the waypoint s′ by performing the action a, v (s′) is the waypoint value of the waypoint s′, and A is a set of executable actions of the driverless vehicle at the waypoint s, E_{T} (·) is an expected value function based on the transfer model T.

After the waypoint value of the previous waypoint corresponding to the target waypoint is calculated, the previous waypoint corresponding to the target waypoint is used as the target waypoint, and the process is returned to step S1031 to calculate a waypoint value of a previous waypoint corresponding to a new target waypoint until the previous waypoint corresponding to the target waypoint is the current position of the driverless vehicle. Thus, the waypoint values of all waypoints between the target waypoint and the current position of the driverless vehicle are obtained. Referring to FIG. 4, after the waypoint values of the previous waypoints S3, S4, and S5 corresponding to the target waypoint are calculated, the waypoints S3, S4, and S5 are used as the new target waypoints. In this case, the waypoint values of the previous waypoints S6, S7, S8 corresponding to the waypoints S3, S4, S5 needs to be calculated. After the short-term cost and state transition probability of transferring from the waypoints S6, S7, S8 to the corresponding previous waypoints are calculated, the corresponding short-term cost is superimposed with the waypoint values of S3, S4, and S5, and the waypoint values of waypoints S6, S7, and S8 are calculated by combining a value of the short-term cost superimposing with the waypoint value of the target waypoint and the state transition probability. Then, the waypoints S6, S7, and S8 are used as new targets waypoints to calculate the waypoint values of the previous waypoints corresponding to the waypoints S6, S7, and S8, and so on. The waypoint value of each waypoint between the target waypoint and the current position of the driverless vehicle is obtained by iteration calculation.

In the case that the waypoint value of each waypoint between the destination and the driverless vehicle is iteratively calculated directly starting from the destination to obtain the optimal route decision, the calculation amount is very large when the driverless vehicle is far away from the destination, affecting the road decision efficiency of the driverless vehicle. In an embodiment of the present disclosure, a process of calculating the waypoint value is divided into two parts. One part is to obtain the global cost of the target waypoint through a global search of the target waypoint, and the other part is to superimpose the global cost of the target waypoint onto the waypoint between the target waypoint and the current position of the driverless vehicle based on the short-term cost and state transition probability of the driverless vehicle transferring between different waypoints. In this way, the calculation amount is reduced, allowing the driverless vehicle to obtain the optimal route decision with a small amount of calculations and improving the route decision efficiency.

In Step 104, an action of the driverless vehicle at the current position is determined according to a waypoint value of a next waypoint corresponding to the current position of the driverless vehicle in real time, and a current route decision result for driving to the destination is obtained.

The route decision is made in real time based on current waypoint value of each waypoint, to determine whether the action at the current position is to change the lane to left, maintain the lane, or change the lane to right. Specifically, based on the waypoint values of the next waypoints in the current lane where the current position of the driverless vehicle is located and the adjacent lane of the current lane, a minimum waypoint value in the waypoint values of the next waypoints corresponding to the current position of the driverless vehicle is determined in real time. Whether and how to change the lane is determined based on the location of the waypoint corresponding to the minimum waypoint value. Referring to FIG. 4, it is assumed that the driverless vehicle is currently located at the waypoint S4. According to the waypoint values of the next waypoints S0, S1, and S2 corresponding to waypoint S4, it can be determined that the waypoint value of waypoint S1 is the smallest, and the waypoint S1 is located directly in front of waypoint S4. That is, the waypoint S1 and the waypoint S4 are in the same lane. Therefore, the driverless vehicle chooses to maintain the lane at waypoint S4 and goes straight to waypoint S1. That is, the route decision result at waypoint S4 is to maintain the lane. When the driverless vehicle reaches the waypoint S1, whether and how to change the lane are determined, based on the minimum value of the waypoint values of the next waypoints of the waypoint S1 in the current lane and in the adjacent lane of the current lane, to obtain the route decision result at the waypoint S4. The above steps are repeated to make route decisions and drive to the destination.

In an embodiment, when the number of the target waypoints between the current position of the driverless vehicle and the destination is one, the waypoint value of each waypoint between the target waypoint and the current position of the driverless vehicle is calculated based on the waypoint value of the target waypoint, and then the route decision is made in real time based on the waypoint value of the next waypoint corresponding to the current position of the driverless vehicle. When the driverless vehicle drives to the target waypoint based on the route decision result, the waypoint value of each waypoint between the destination and the current position of the driverless vehicle (i.e., the target waypoint) can be calculated based on the waypoint value of the destination, and the route decision is made based on the waypoint value of the next waypoint corresponding to the target waypoint of the driverless vehicle, to drive the driverless vehicle to the destination. The waypoint value of the destination can be set to zero or other relatively small value. The process of calculating the waypoint value of the waypoint between the destination and the target waypoint is similar with the process of calculating the waypoint value of the waypoint between the target waypoint and the current position of the driverless vehicle.

In an embodiment, in order to further improve calculation efficiency, multiple target waypoints can be set at one time between the current position of the driverless vehicle and the destination, each target waypoint is spaced a certain distance along a driving direction of the driverless vehicle. After the waypoint value of each target waypoint is calculated through step 102, the target waypoint that the driverless vehicle reaches first can be set as a first target waypoint (that is, the target waypoint closest to the driverless vehicle), and the target waypoint that the driverless vehicle reaches second can be set as the second target waypoint (that is, the target waypoint that is the second closest to the driverless vehicle), and so on. The waypoint value of each waypoint between the first target waypoint and the current position of the driverless vehicle is calculated based on the waypoint value of the first target waypoint, and the route decision is made based on the waypoint value of the next waypoint corresponding to the current position of the driverless vehicle in real time. When the driverless vehicle drives to the first target waypoint according to the route decision result, the waypoint value of each waypoint between the second target waypoint and the current position of the driverless vehicle (that is, the first target waypoint) is calculated according to the waypoint value of the second target waypoint, and so on. When the driverless vehicle reaches the last target waypoint, the waypoint value of each waypoint between the destination and the current position of the driverless vehicle (the last target waypoint) is calculated according to the waypoint value of the destination, and then the route decision is made in real time based on the waypoint value of the next waypoint corresponding to the last target waypoint, to drive the driverless vehicle to the destination.

Referring to FIG. 2, it is assumed that the destination is a certain position in front of the hub center 1, the driverless vehicle is currently located behind a hub center 2, the hub center 1 and the hub center 2 are between the destination and the current position of the driverless vehicle, and entry points of the hub center 1 and the hub center 2 are selected as the target waypoints. It can be determined that the waypoint corresponding to the entry point of hub center 2 is the first target waypoint and the waypoint corresponding to the entry point of the hub center 1 is the second target waypoint, according to the distance between the entry point of the hub center 1 and the current position of the driverless vehicle and the distance between the entry point of the hub center 2 and the current position of the driverless vehicle. When the waypoint values of other waypoints are calculated according to the waypoint value of the target waypoint, the waypoint value of each waypoint from the entry point of the hub center 2 to the current position of the driverless vehicle is calculated firstly, according to the waypoint value of the entry point of the hub center 2, and then the route decision is made in real time according to the waypoint value of the next waypoint corresponding to the current position of the driverless vehicle. When the driverless vehicle is driven to a certain entry point of the hub center 2, the waypoint value of the waypoint between the entry point of the hub center 1 and the entry point of the hub center 2 can be calculated based on the waypoint value of the entry point of the hub center 1, and then the route decision is made. When the driverless vehicle is driven to a certain entry point of the hub center 1, the waypoint value of the waypoint between the destination and the entry point of the hub center 1 can be calculated according to the waypoint value of the destination, and then the route decision is made based on the waypoint value to drive the driverless vehicle to the destination. When the driverless vehicle is far away from the destination, multiple target waypoints can be selected to calculate the waypoint value of each waypoint in stages. The total calculation amount is allocated to the calculation process of each stage, thereby increasing the calculation speed and improving the decision efficiency. By setting multiple target waypoints, the driverless vehicle takes the target waypoints as the destinations of the respective stages, gradually drives through each target waypoint, and finally reaches the destination.

In an embodiment of the present disclosure, the drivable road between the driverless vehicle and the destination is divided into waypoints, and the waypoint value of each waypoint is calculated. The driverless vehicle can make route decision at each waypoint according to the waypoint value of the next waypoint, which simplifies a complex route decision optimization problem. The waypoint value is calculated in two stages. In the first stage, the global cost from the target waypoint to the destination is calculated to obtain the waypoint value of the target waypoint. In the second stage, a reverse iteration is performed to calculate the waypoint value of the waypoint between the target waypoint and the current position of the driverless vehicle according to the waypoint value of the target waypoint. In this way, the calculation speed of the waypoint value and the route decision efficiency are improved, thereby improving the technical problems that in the conventional technology, a model predictive control method is used to obtain an optimal route decision, and a process of obtaining the optimal route decision by solving complex optimization problems requires a large amount of computing power to solve nonlinear optimization problems, which results in low route decision efficiency.

The above describes an embodiment of a route decision method according to the present disclosure, and the other embodiment of a route decision method according to the present disclosure will be described as follows.

A route decision method is provided according to an embodiment of this present disclosure. The method includes step 201 to step 204.

In step 201, a drivable road between a current position of a driverless vehicle and a destination is divided into multiple waypoints, where the drivable road includes at least one lane, and each lane includes a plurality of waypoints connected in sequence.

In step 202, a target waypoint is determined from the waypoints between the current position of the driverless vehicle and the destination, and a global cost from the target waypoint to the destination is calculated to obtain a waypoint value of the target waypoint.

In step 203, iteration is performed to calculate the waypoint value of the waypoint between the target waypoint and the current position of the driverless vehicle based on the waypoint value of the target waypoint.

In step 204, an action at the current position is determined according to the waypoint value of a next waypoint corresponding to the current position of the driverless vehicle in real time, and a current route decision result for driving to the destination is obtained.

The specific content of step 201 to step 204 is consistent with that of the aforementioned step 101 to step 104, which will not be repeated herein.

In the above steps, waypoint values are obtained and the route decision is made based on the static traffic information. However, the traffic environment in which driverless vehicles are actually driving is dynamic and changes over time. In addition, many other traffic participants are in the traffic environment, which may dynamically affect the single-step cost function and the transfer model of the driverless vehicle and ultimately affect the waypoint value of each waypoint. Therefore, in the driving process of the driverless vehicle, waypoint values need to be updated based on traffic information, and then the route decision result may be updated.

Furthermore, the route decision method in the embodiment of this present disclosure further includes step 205 as follow.

In step 205, the route decision result is updated according to the traffic information.

The specific process of updating the route decision includes step 2051 to step 2054 as follows.

In S2051, when the driverless vehicle is driven according to the current route decision result, a special waypoint affected by traffic information is obtained.

When the driverless vehicle is driven according to the current route decision result, traffic information can be obtained in real time through a sensor on the driverless vehicle or from vehicle-to-everything.

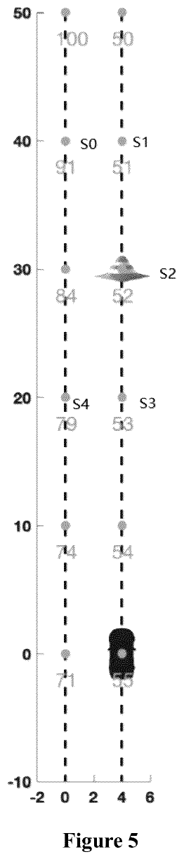

In the case that the traffic information includes a static traffic participant (a vehicle parked on the road side, traffic cones, and the like), when the driverless vehicle is driven according to the current route decision result, the special waypoint affected by the static traffic participant is determined according to a position of the static traffic participant. When a static traffic participant is located at a certain waypoint, this waypoint is the special waypoint. Referring to FIG. 5, in a traffic scene, a driverless vehicle is driven on the right lane and finds that a traffic cone 30 meters ahead blocks the right lane. The driverless vehicle can predict that the driverless vehicle cannot be driven from the waypoint S3 to waypoint S2 through maintaining lane in the future, cannot be driven from the waypoint S4 to the waypoint S2 through changing the lane to right, and cannot be driven from the waypoint S2 to the waypoint S1 through maintaining the lane, and cannot be driven from the waypoint S2 to the waypoint S0 through changing the lane to left. That is, according to the position of the traffic cone, the special waypoint to be affected by the traffic cone may be determined as the waypoint S2. In the case that the static traffic participant is located between two waypoints, for example, the traffic cone is located between the waypoint S2 and the waypoint S1 in FIG. 5, the driverless vehicle can predict that it cannot be driven from the waypoint S2 to the waypoint S1 by maintaining the lane in the future. Thus, the affected special waypoint can be determined as the waypoint S2.

In the case that the traffic information includes dynamic traffic participants, when the driverless vehicle is driven according to the current route decision result, the target dynamic traffic participant is determined from the dynamic traffic participants. The special waypoint affected by target dynamic traffic participant is determined according to the driving speed of the target dynamic traffic participant and the driving speed of the driverless vehicle.

In a driving process of the driverless vehicle, there may be multiple dynamic traffic participants (pedestrians, driving vehicles, and the like). In consideration of the dynamic impact of all dynamic traffic participants, the computational load is very large. In order to reduce the computational load, increase the update speed of waypoint value and improve the route decision efficiency. In an embodiment of the present disclosure, priority will be given to the dynamic traffic participant within the preset range in front of the driverless vehicle and having a driving speed lower than the lane speed limit.

Furthermore, a specific process of determining the target dynamic traffic participant from dynamic traffic participants may include: utilizing the dynamic traffic participant within the preset range in front of the driverless vehicle as a potential target dynamic traffic participant; determining whether a driving speed of the potential target dynamic traffic participant is less than a speed limit value of the lane where the potential target dynamic traffic participant is located, to obtain a determination result; calculating a confidence of the potential target dynamic traffic participant according to a priori value and the determination result of the potential target dynamic traffic participant; and determining a target traffic participant from the potential target dynamic traffic participant based on the confidence.

The behavior of the dynamic traffic participant is uncertain. When the special waypoint to be affected by the target dynamic traffic participant is determined, it is necessary to determine which target traffic participant has the dynamic influence on the waypoint value. For example, if the preceding vehicle of the driverless vehicle starts to accelerate after only driving slowly for one second, the preceding vehicle has little influence on the waypoint value, and the influence of the preceding vehicle can be ignored. If the preceding vehicle of the driverless vehicle drives slowly for a period of time, it is necessary to consider the dynamic impact of the preceding vehicle on the waypoint value.

Specifically, after the potential target dynamic traffic participants are determined, priori values can be configured for the respective potential target dynamic traffic participants. After obtaining the determination result of whether the driving speed of each potential target dynamic traffic participant is less than the speed limit value of the lane where the potential target dynamic traffic participant is located, the determination result can be mapped to a numerical value through a mapping function. For example, the determination result that the driving speed of the potential target dynamic traffic participant is less than the speed limit value of the lane can be mapped to a value 1, and the determination result that the driving speed of the potential target dynamic traffic participant is greater than or equal to the speed limit value of the lane is mapped to a value of 0. Then, the priori values of the potential target dynamic traffic participants and the mapping values corresponding to the determination results are weighted and summed by preset weight coefficients, to obtain the confidence of the potential target dynamic traffic participants. When the confidence of one of the potential target dynamic traffic participant is greater than a preset confidence threshold for a period of time, this potential target dynamic traffic participant is determined as the target dynamic traffic participant, which can avoid the potential target dynamic traffic participant who accelerate or decelerate suddenly as the target dynamic traffic participant.

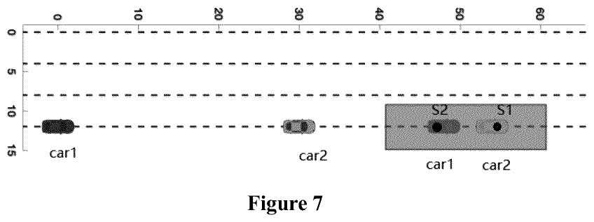

After the target dynamic traffic participant is determined, the special waypoint to be affected by the target dynamic traffic participant is determined according to the driving speed of the target dynamic traffic participant and the driving speed of the driverless vehicle. Referring to FIG. 7, in a traffic scene, a driverless vehicle (car1) is traveling at a constant speed v₁, and a vehicle (car2) in front of the driverless vehicle is traveling at a constant speed v₂, where v₁>v₂. It is assumed that the current decision result of the driverless vehicle, which is obtained according to the waypoint values calculated from the static traffic information, is to maintain the lane. That is, the right lane is the best lane currently. The waypoint values of these waypoints do not consider the dynamic influence of the slow-moving vehicle in front. Since v₁>v₂, in a certain area ahead (the area is estimated by a speed difference between the driverless vehicle and the preceding vehicle), that is, in a shadow area of FIG. 7, the driverless vehicle will be close to the preceding vehicle, so that the driverless vehicle will be affected by the slow-moving preceding vehicle in the shadow area. If the driverless vehicle continues to go straight, the speed of the driverless vehicle needs to reduce to follow the preceding vehicle. Thus, the short-term cost of the driverless vehicle of transferring from the waypoint S2 to the waypoint S1 will increase, which will affect the waypoint value of the waypoint S2. That is, the waypoint S2 is a special waypoint to be affected by the preceding vehicle.

In S2052, when the special waypoint is a waypoint to be reached in the future based on the current route decision result, the next waypoint of the special waypoint is determined based on the current route decision result, and the short-term cost of the special waypoint to the next waypoint is updated.

When the special waypoint is a waypoint affected by static traffic participants, as shown in FIG. 5, the special waypoint is the waypoint S2, the next waypoint of the waypoint S2 can be determined as the waypoint S1 based on the current route decision result (maintaining the lane). Since a traffic cone is located at the waypoint S2, the driverless vehicle cannot reach the waypoint S1 from the waypoint S2. The short-term cost C (S2, maintain the lane, S1) from the special waypoint S2 to the waypoint S1 can be updated to a large value (such as 50, 100, and the like), the specific value of which can be set according to an actual situation.

Furthermore, when the special waypoint is a waypoint affected by the target dynamic traffic participant, the update process of the short-term cost from the special waypoint to the corresponding next waypoint may include: in the case that the special waypoint is a waypoint to be reached in the future based on the current route decision result, determining a next waypoint of the special waypoint based on the current route decision result, and determining a driving distance from the special waypoint to the next waypoint; and calculating a short-term cost of the driverless vehicle from the special waypoint to the next waypoint based on the driving distance and the driving speed of the target traffic participant, to obtain an updated short-term cost from the special waypoint to the next waypoint.

Taking FIG. 7 as example, the next waypoint of the special waypoint S2 can be determined to be the waypoint S1, according to the current route decision result (maintaining the lane). According to the driving distance d between the special waypoint S2 and the waypoint S1 and the driving speed v₂ of the preceding vehicle of the driverless vehicle, the updated short-term cost s/v₂ from the special waypoint S2 to the waypoint S1 can be calculated. In the embodiment of the present disclosure, the dynamic impact of the target dynamic traffic participants may last for a certain period of time. Therefore, finally, the updated short-term cost C(s,a,s′) from a special waypoint s to the next waypoint s′ after executing the action a can be expressed as:

$$C ( s , a , {s}^{′} ) = {β}^{*} ( {d}_{{s}^{′} - s} / v ) .$$

In the above formula, R is a truncation parameter, which is configured to determine a duration of the dynamic influence of the target dynamic traffic participant; d_{s′-s} is the driving distance from the special waypoint s to the corresponding next waypoint s′; and v is the driving speed of the target dynamic traffic participant.

In S2053, the waypoint value of the special waypoint is updated based on the updated short-term cost from the special waypoint to the next waypoint.

According to the previous steps, a waypoint value of a waypoint is calculated from the waypoint value of the next waypoint corresponding to the waypoint, the short-term cost and the state transition probability of transferring between waypoints. After the short-term cost is updated, the corresponding waypoint value may also be updated. It can be understood that when the state transition probability is updated, the corresponding waypoint value may also be updated.

Taking FIG. 5 as example, it is assumed that in a static traffic environment, the short-term cost of transferring between waypoints is 1, the lane change success rate is 20%, and the short-term cost, C(S2, maintain the lane, S1)=100, of transferring from the special waypoint S2 to the waypoint S0. Since it is impossible to transfer from the special waypoint S2 to the waypoint S0, the short-term cost of transferring from the special waypoint S2 to the waypoint S0 may increase. It is assumed that the updated short-term cost of transferring the special waypoint S2 to the waypoint S0 is C (S2, change lane to left, S0)=100.

If changing the lane to left is selected at the special waypoint S2, the updated waypoint value is V(S2)_{change lane to left}=(91+100)*20%+(51+100)*80%=159.

If maintaining the lane is selected at the special waypoint S2, the updated waypoint value is V(S2)_{maintain lane}=(51+100)*100%=151.

Finally, the updated waypoint value of the special waypoint S2 is min(V(S2)_{change lane to left}, V(S2)_{maintain lane})=151.

It can be understood that in the case that the traffic cone is located between the waypoint S2 and the waypoint S1, changing the lane to left can be selected at the special waypoint S2, to drive to the waypoint S0. At this time, the short-term cost of transferring from the special waypoint S2 to the waypoint S0 remains unchanged, that is, C(S2, change lane to left, S0)=1. In this case, if changing the lane to left is selected at the special waypoint S2, the updated waypoint value is V(S2)_{change lane to left}=(91+1)*20%+(51+100)*80%=139. Finally, the updated waypoint value of the special waypoint S2 is min(V(S2)_{change lane to left}, V(S2)_{maintain lane})=139.

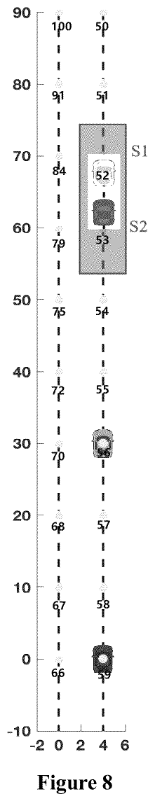

Taking FIG. 8 as example, it is assumed that in a static traffic environment, the short-term cost of transferring between the waypoints is 1, and the lane change success rate is 20%. The waypoint values calculated according to the static traffic information are shown in FIG. 8. It is assumed that the updated short-term cost of transferring from the special waypoint S2 to the waypoint S1 is 30.

If changing the lane to left is selected at the special waypoint S2, the updated waypoint value is V(S2)_{change lane to left}=(84+1)*20%+(52+30)*80%=83.

If maintaining the lane is selected at the special waypoint S2, the updated waypoint value is V(S2)_{maintain lane}=(52+30)*100%=82.

Finally, the updated waypoint value of the special waypoint S2 is min(V(S2)_{change lane to left}, V(S2)_{maintain lane})=82.

In S2054, a reverse iteration is performed to update the waypoint value of each waypoint between the special waypoint and the current position of the driverless vehicle according to the updated waypoint value of the special waypoint, and the process is returned to step 204.

Referring to FIG. 5, the driverless vehicle cannot reach the waypoint S2, through the maintaining the lane at the waypoint S3. Therefore, the short-term cost from the waypoint S3 to the special waypoint S2 needs to be updated. It is assumed that the updated short-term cost C(S3, maintain lane, S2)=100.

If changing the lane to left is selected at the waypoint S3, the updated waypoint value is V(S3)_{change lane to left}=(84+1)*20%+(139+100)*80%=208.

If maintaining the lane is selected at the waypoint S3, the updated waypoint value is V(S3)_{maintain lane}=(139+100)*100%=239.

Finally, the updated waypoint value of the waypoint S3 is min(V(S3)_{change lane to left}, V(S3)_{maintain lane})=208.

The short-term cost from the waypoint S4 to the special waypoint S2 also needs to be updated accordingly. The update process of the waypoint value of the waypoint S4 is similar to that of the waypoint S3, which will not be repeated herein. After the waypoint values of the waypoint S3 and the waypoint S4 are updated, the reverse iteration is performed to update the waypoint values of waypoints from the waypoints S3 and S4 to the current position of the driverless vehicle. It should be noted that the short-term costs of the waypoints from the waypoints S3 and S4 to the current position of the driverless vehicle remain unchanged.

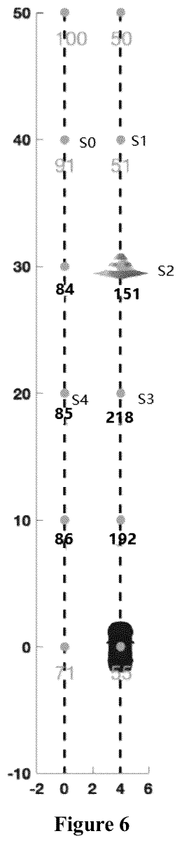

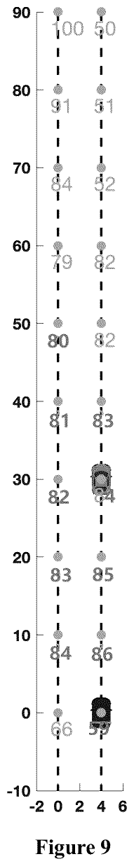

After the waypoint values in FIG. 5 are updated, the updated waypoint values are shown in FIG. 6. It can be seen that the driverless vehicle will change the lane to the left lane at the current waypoint and pass by the traffic cone, according to the updated waypoint values. After the waypoint values in FIG. 8 are updated, the updated waypoint values are shown in FIG. 9. It can be seen that the driverless vehicle will change the lane to the left lane and overtake a slow vehicle ahead, according to the updated waypoint values in FIG. 9.

The time is not considered in the calculation of the waypoint value of each waypoint in the static traffic environment. That is, the influence of the dynamic traffic environment is not considered. When there is an extremely slow dynamic traffic participant in front of the driverless vehicle, the driverless vehicle will take a huge amount of time to move from the current waypoint to the next waypoint. That is, the short-term cost of the driverless vehicle of transferring between waypoints is closely related to the traffic environment. The short-term cost can be updated based on each frame of the traffic information and can change dynamically. Correspondingly, the waypoint value may also change dynamically. In an embodiment of the present disclosure, an update formula of the waypoint value of each waypoint between the special waypoint and the current position of the driverless vehicle can be expressed as:

$$V ( s ) = {min}_{a ∈ A} {E}_{{T}_{t} , {π}_{t}^{- e}} [ {C}_{t} ( s , a , {s}^{′} ) + V ( {s}^{′} ) ] .$$

In the update formula, v (s) is an updated waypoint value of the waypoint s, Cₜ(s, a, s′) is the short-term cost of the driverless vehicle from the waypoint s to the waypoint s′ through performing an action a at the current time t, V(s′) is the waypoint value of the waypoint s′, and A is a set of executable actions of the driverless vehicle at the waypoint s. E_{T}_{ₜ}_{,π}_{ₜ}_{^{−e}}(·) is an expected value function based on the time-varying transfer model Tr and a set πₜ^{-e} of traffic participants at the current moment t.

Due to a presence of other traffic participants, the transfer model is dependent on time. At each moment, the current waypoint (that is, the current state) of the driverless vehicle is known, and the reached state of the driverless vehicle when selecting an executable action (changing the lane to left, changing the lane to right, or maintaining lane) is uncertain. For example, the traffic density of the target change lane after changing the lane is close to capacity of the target change lane, or a following vehicle on the target change lane after changing the lane is rapidly approaching. In this case, even if the driverless vehicle makes a lane change action, the driverless vehicle may be not successful change the lane to the target change lane. Therefore, it is necessary to dynamically update the lane change success rate between waypoints by observing the traffic information around the driverless vehicle. The executable actions are determined by the lane in which the driverless vehicle is located. For example, if the driverless vehicle is in the rightmost lane and no drivable road is at the right of the driverless vehicle, changing the lane to right is a non-executable action, and going straight and changing the lane to left are executable actions.

In an embodiment, for waypoints outside the preset range of the driverless vehicle, the success rate P (succ .ₜ=1) of the lane change between the waypoints outside the preset range of the driverless vehicle is the same as the success rate P₀ of the lane change calculated in the static traffic environment, that is, P (succ .ₜ=1)=P₀. For waypoints within the preset range of driverless vehicles, the lane change success rate when transferring between the waypoints within the preset range of the driverless vehicle is updated based on the traffic information.

Specifically, the current distance between the vehicle on the rear side of the driverless vehicle and the driverless vehicle and the current giving-way probability of the rear side vehicle of the driverless vehicle are obtained based on the traffic information, and the lane change success rate of the driverless vehicle at the current waypoint is updated.

For the lane change success rate of the driverless vehicle at the current waypoint, it is necessary to consider the current distance dₜ between the rear side vehicle of the driverless vehicle and the driverless vehicle and the current giving-way probability P(succ .ₜ=1|yₜ)(influenced by a giving-way willingness yₜ of the rear side vehicle) of the rear side vehicle of the driverless vehicle. That is, the success rate P (succ .ₜ=1|dₜ, yₜ) of the lane change of the driverless vehicle at the current waypoint can be expressed as:

$$P ( succ {.}_{t} = 1 \vert {d}_{t} , {y}_{t} ) ∝ P ( succ {.}_{t} = 1 \vert {d}_{t} ) \cdot P ( succ {.}_{t} = 1 \vert {y}_{t} ) .$$

In the formula, P (succ .ₜ=1|dₜ) is configured to control the lane change success rate based on the current distance between the driverless vehicle and the rear side vehicle thereof, and P (succ .ₜ=1|yₜ) is configured to control the lane change success rate based on the cooperation of the rear side vehicle, and a is a proportional sign.

Furthermore, a calculation formula of P (succ .ₜ=1 dₜ) can be:

$$P ( succ {.}_{t} = 1 \vert {d}_{t} ) = \frac{2 {P}_{0} {d}_{t}}{{d}_{t} + {d}_{safe}} .$$

In the calculation formula, P₀ is the lane change success rate at the current waypoint calculated in a static traffic environment, that is, the lane change success rate before the current waypoint is updated; and d_{safe} is a safe lane change distance, when dₜ=d_{safe}, P(succ .ₜ=1|dₜ)=P0.

Furthermore, the calculation process of the current giving-way probability of the rear side vehicle of the driverless vehicle may include: calculating the current giving-way probability of the rear side vehicle according to the current acceleration of the rear side vehicle of the driverless vehicle and the giving-way probability of the rear side vehicle at a previous moment, where an initial giving-way probability of the rear side vehicle is obtained by initialization. The calculation formula of P(succ .ₜ=1|yₜ) can be expressed as:

$$P ( succ {.}_{t} = 1 \vert {y}_{t} ) = α P ( succ {.}_{t - 1} = 1 \vert {y}_{t - 1} ) + ( 1 - α ) II ( {α}_{t} < 0 ) .$$

In the calculation formula, P(succ .ₜ=1|yₜ) is the current giving-way probability of the rear side vehicle of the driverless vehicle; P(succ .ₜ₋₁=1|yₜ₋₁) is the giving-way probability of the rear side vehicle at the previous moment; α is a update rate; αₜ is the current acceleration of the rear side vehicle; and II(*) is a mapping function, where when an event * is true, II(*)=1, when the event * is false, II(*)=0, that is, when aₜ<0, II(a, <0)=1, when aₜ≥0, (a, <0)=0.

The initial giving-way probability of the rear side vehicle is obtained through initialization. The initial giving-way probabilities of different rear side vehicles may have the same initial value. In the driving process, the giving-way probability of the rear side vehicle may be updated according to the reaction of the rear side vehicle.

For the remaining waypoints within the preset range of the driverless vehicle, that is, other waypoints within the preset range of the driverless vehicle except the current waypoint where the driverless vehicle is located, the lane change success rate at each remaining waypoints within the preset range of the driverless vehicle is updated based on the traffic density of the target change lane. The target change lane is a lane after the lane change, which can be expressed as:

$$P ( succ {.}_{t} = 1 \vert {ρ}_{t} ) = \frac{{β}^{1 - \frac{{ρ}_{t}}{δ}} - 1}{β - 1} {P}_{max} .$$

In the formula, P(succ .ₜ=1|ρₜ) is the lane change success rate at the remaining waypoints within the preset range of the driverless vehicle under the traffic density at time t; β is an attenuation factor; ρₜ is the traffic density of the target change lane at time t; a is the traffic capacity of the target change lane; and Pₘₐₓ is a lane change success rate threshold.

Furthermore, when the special waypoint affected by the static traffic participants is a waypoint to be reached in the future according to the current route decision result, and the adjacent lane of the lane including the special waypoint is impassable, the method according to the embodiment of the present disclosure further includes: dividing a lane line between the lane where the special waypoint affected by static traffic participants is located and the adjacent lane thereof into multiple waypoints connected in sequence; and calculating the waypoint value of each waypoint on the lane line according to the waypoint values of the waypoints on the adjacent lanes of the lane line, the short-term cost and state transition probability of transferring between waypoints, and returning to step 204. The short-term cost of transferring between waypoints on the lane line may be higher than that on a normal lane. A specific value of the short-term cost on the lane line can be set according to an actual situation.

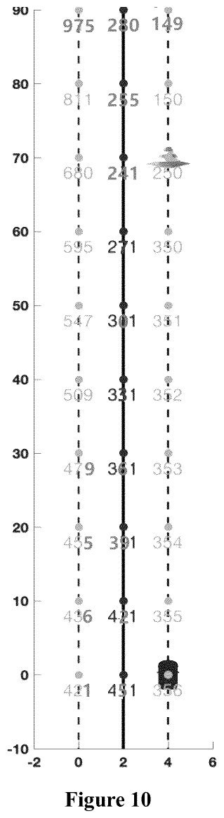

For example, as shown in FIG. 10, in a traffic scene, two lanes is in front of the driverless vehicle, the driverless vehicle is traveling in the right lane, a traffic cone is in front of the driverless vehicle in the right lane, and the left lane leads to a dead end. In this case, the calculated waypoint value of each waypoint in the left lane is much higher than that in the right lane. That is, the short-term cost of the driverless vehicle changing from the right lane to the left lane is very high. However, the traffic cone is in front of the driverless vehicle in the right lane, and thus the right lane is impossible to keep going straight. In this case, the lane line between the left lane and the right lane (i.e., the solid line in FIG. 10) can be divided into multiple waypoints connected in sequence. Then, the waypoint values of the waypoints on the lane line are calculated by the waypoint value update formula in the above step S2053. When the waypoint value of any one waypoint on the lane line is smaller than the updated waypoint value of the right lane affected by the traffic cone and the waypoint value of the waypoint of the left lane, the driverless vehicle can change the lane to the waypoint on the lane line with low cost, to pass the traffic cone. In a static traffic environment, it is assumed that the short-term cost of transferring between waypoints on the lane is 1, and the short-term cost of transferring between waypoints on the lane line is 30. Due to the influence of traffic cones, the updated short-term cost from the special waypoint on the right lane to the next waypoint is 100. The waypoint value of the waypoint on the lane line obtained based on this calculation is shown in FIG. 10. In this scene, the driverless vehicle keeps going straight for a period of time, and then changes onto the lane line to pass the traffic cone.

In the embodiments of this present disclosure, in the process of obtaining the optimal route decision by the model predictive control method, it is necessary to solve complex optimization problems, which requires a large amount of computing power to solve the nonlinear optimization problem and relies heavily on a construction of environmental models, which is difficult to be effectively applied to the decision system of driverless vehicle. In the embodiments of this present disclosure, the optimization problem is solved in two parts. One part is to obtain the global cost of the target waypoint through a global search for the target waypoints, and the other part is to dynamically correct the short-term cost and the lane change success rate of transferring between different states by observing real-time traffic information. Therefore, the high-dimensional multi-agent optimization problem is simplified into the low-dimensional single-agent optimization problem to improve the solution speed. Through rapid real-time quantitative analysis of the global cost and short-term cost of the passable road for the driverless vehicle, the short-term cost and global cost of the road are balanced, the driverless vehicles can obtain an optimal route decision result by a small amount of calculations, so as to at the optimal time obey global navigation to actively change the lane, actively change the lane to overtake, actively change the lane to escape potential risk areas (such as construction areas, traffic accident areas, and the like), and actively change the lane to avoid priority vehicles (such as police cars, ambulances, and the like).

The other embodiment of the route decision method is provided according to the present disclosure, and the following is an embodiment of a route decision system according to the present disclosure.

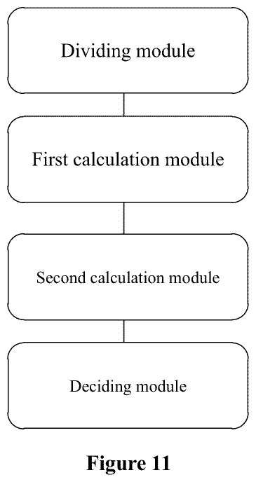

Referring to FIG. 11, a route decision system is provided according to an embodiment of the present disclosure. The system includes as follows.

A dividing module is configured to divide a drivable road between a current position of a driverless vehicle and a destination into multiple waypoints, where the drivable road includes at least one lane, and each lane includes multiple waypoints connected in sequence.

A first calculation module is configured to determine a target waypoint among the waypoints between the current position of the driverless vehicle and the destination, and calculate a global cost from the target waypoint to the destination to obtain a waypoint value of the target waypoint.

A second calculation module is configured to performing an iteration to calculate a waypoint value of a waypoint between the target waypoint and the current position of the driverless vehicle according to the waypoint value of the target waypoint.

A deciding module is configured to determine an action of the driverless vehicle at the current position according to a waypoint value of a next waypoint corresponding to the current position of the driverless vehicle in real time, and obtain a current route decision result for driving to the destination, wherein the action includes changing the lane to left, maintaining the lane, or changing the lane to right.

As a further improvement, the first calculation module is further configured to obtain a shortest path from the target waypoint to the destination in a graph search algorithm; calculate a driving time of the driverless vehicle from the target waypoint to the destination based on the shortest path and a preset driving speed; obtain the global cost from the target waypoint to the destination based on the driving time of the driverless vehicle from the target waypoint to the destination; and utilize the global cost from the target waypoint to the destination as the waypoint value of the target waypoint.

As a further improvement, the route decision system in an embodiment of the present disclosure further includes: a waypoint value update module configured to obtain a special waypoint affected by traffic information, in a process of driving the driverless vehicle according to the current route decision result; in the case the special waypoint is a waypoint to be reached in the future based on the current route decision result, determine a next waypoint of the special waypoint based on the current route decision result, and update a short-term cost from the special waypoint to the next waypoint; update a waypoint value of the special waypoint based on the updated short-term cost from the special waypoint to the next waypoint; and perform a reverse iteration to update the waypoint value of each waypoint between the special waypoint and the current position of the driverless vehicle according to the updated waypoint value of the special waypoint, and trigger the deciding module.

As a further improvement, the route decision system in an embodiment of the present disclosure further includes: a third calculation module configured to, in the case that the special waypoint affected by a static traffic participant is a waypoint to be reached in the future according to the current route decision result and an adjacent lane of the lane where the special waypoint is located is impassable, divide a lane line between the current lane where the special waypoint affected by the static traffic participant is located and the adjacent lane into multiple waypoints connected in sequence; and calculate the waypoint value of each waypoint on the lane line according to the waypoint values of the waypoints on the adjacent lane of the lane line, the short-term cost and state transition probability of the transferring between waypoints, and trigger the deciding module.

As a further improvement, the state transition probability includes a lane change success rate, and the route decision system in an embodiment of the present disclosure further includes: a lane change success rate update module configured to update the lane change success rate when the driverless vehicle transfers between waypoints within a preset range of the driverless vehicle, according to traffic information.

As a further improvement, the lane change success rate update module is further configured to obtain a current distance between a rear side vehicle of the driverless vehicle and the driverless vehicle and a current giving-way probability of the rear side vehicle of the driverless vehicle based on the traffic information, and update the lane change success rate of the driverless vehicle at the current waypoint; and update the lane change success rate of remaining waypoints within the preset range of the driverless vehicle based on a traffic density of the target change lane, where the target change lane is a lane after a lane change, and the remaining waypoints within the preset range of the driverless vehicle are waypoints within the preset range of the driverless vehicle except the current waypoint where the driverless vehicle is located.

In the embodiments of the present disclosure, the drivable road between the driverless vehicle and the destination is divided into multiple waypoints. By calculating the waypoint value of each waypoint, the driverless vehicle can make route decisions at each waypoint according to the waypoint value of the next waypoint, which simplifies a complex route decision optimization problem and calculates waypoint values in two stages. In a first stage, the global cost from the target waypoint to the destination is calculated, and the waypoint value of the target waypoint is obtained. In a second stage, a reverse iteration is performed to calculate the waypoint value of the waypoint between the target waypoint and the current position of the driverless vehicle according to the waypoint value of the target waypoint. Thus, the calculation speed of the waypoint value and the route decision efficiency are improved, improving the technical problems that in the conventional technology, a model predictive control method is used to obtain an optimal route decision and a process of obtaining the optimal route decision by solving complex optimization problems requires a large amount of computing power to solve nonlinear optimization problems, which results in low route decision efficiency.

A route decision device is further provided according to an embodiment of the present disclosure, which includes a processor and a memory.

The memory is configured to store program codes and transmit the program codes to the processor.

The processor is configured to execute instructions in the program codes to implement the route decision method in the above method embodiment.

A computer-readable storage medium is further provided according to an embodiment of the present disclosure. The computer-readable storage medium is configured to store program codes. A processor, when executing the program codes, implements the route decision method in the above method embodiment.

Those skilled in the art can clearly understand that for the convenience and simplicity of description, the specific working processes of the system, device and unit described above can be referred to the corresponding processes in the above method embodiments, which will not be repeated herein.

The terms “first”, “second”, “third”, “fourth”, etc. (if any) in the description of the present disclosure and the above drawings are configured to distinguish similar objects and not necessarily to describe specific sequence. It can be understood that the data can be interchangeable under appropriate circumstances such that the embodiments of the present disclosure described herein, for example, can be practiced in sequences other than those illustrated or described herein. Furthermore, the terms “comprising” and “including”, as well as any variations thereof, are intended to cover a non-exclusive inclusion, for example, a process, method, system, product or device comprising a sequence of steps or elements is not necessarily limited to the expressly listed those steps or elements, may include other steps or elements not expressly listed or inherent to the process, method, product or apparatus.

It should be understood that in this disclosure, “at least one (item)” refers to one or more, and “plurality” refers to two or more. “And/or” is configured to describe the association relationship of associated objects, indicating that there can be three types of relationships, for example, “A and/or B” can mean: only A exists, only B exists, and A and B exist at the same time, where A and B can be singular or plural. The character “/” generally indicates that the related objects are in an “or” relationship. “At least one of the following” or similar expressions refer to any combination of these items, including any combination of single or plural items. For example, at least one (item) of a, b or c can include: a, b, c, “a and b”, “a and c”, “b and c”, or “a and b and c”, where a, b, c can be single or multiple.

In the several embodiments provided in the present disclosure, it should be understood that the disclosed devices and methods can be implemented in other ways. For example, the device embodiments described above are only illustrative. For example, the division of the units is only a logical function division. In an actual implementation, there may be other division methods. For example, multiple units or components can be combined or can be integrated into another system, or some features can be ignored, or not implemented. In another point, the mutual coupling or direct coupling or communication connection shown or discussed may be through some interfaces, and the indirect coupling or communication connection of devices or units may be in electrical, mechanical or other forms.

The units described as separate components may or may not be physically separated, and the components shown as units may or may not be physical units, that is, they may be located in one place, or may be distributed to multiple network units. Some or all of the units can be selected according to actual needs to achieve the purpose of the solution of this embodiment.

In addition, each functional unit in each embodiment of the present disclosure may be integrated into one processing unit, each unit may exist separately physically, or two or more units may be integrated into one unit. The above integrated units can be implemented in the form of hardware or software functional units.

If the integrated unit is realized in the form of a software function unit and sold or configured as an independent product, it can be stored in a computer-readable storage medium. Based on this understanding, the technical solution of the present disclosure is essentially or part of the contribution to the conventional technology or all or part of the technical solution can be embodied in the form of a software product, and the computer software product is stored in a storage medium, including several instructions for executing all or part of the steps of the methods described in the various embodiments of the present disclosure through a computer device (which may be a personal computer, a server, or a network device, and the like). The above storage media include: U disk, mobile hard disk, read-only memory (English full name: Read-Only Memory, English abbreviation: ROM), random access memory (English full name: Random Access Memory, English abbreviation: RAM), and various media for storing program codes, such as magnetic discs or optical discs.

As mentioned above, the above embodiments are only configured to illustrate the technical solutions of the present disclosure, which will not limit the present disclosure. Although the present disclosure has been described in detail with reference to the above embodiments, those of ordinary skill in the art should understand that: a modification can be made on the above technical solutions described in each embodiment, or some of the technical features can be equivalently replaced. These modifications or replacements do not make the essence of the corresponding technical solutions deviate from the spirit and scope of the technical solutions of the various embodiments of the disclosure.

1. A route decision method, comprising:
dividing a drivable road between a current position of an driverless vehicle and a destination into a plurality of waypoints, wherein the drivable road comprises at least one lane, and the lane comprises waypoints connected in sequence;
determining a target waypoint among the waypoints between the current position of the driverless vehicle and the destination, and calculating a global cost from the target waypoint to the destination to obtain a waypoint value of the target waypoint;
performing an iteration to calculate a waypoint value of a waypoint between the target waypoint and the current position of the driverless vehicle, according to the waypoint value of the target waypoint; and
determining an action of the driverless vehicle at the current position based on a waypoint value of a next waypoint corresponding to the current position of the driverless vehicle in real time, and obtaining a current route decision result for driving to the destination.

2. The route decision method according to claim 1, wherein the calculating the global cost from the target waypoint to the destination to obtain the waypoint value of the target waypoint comprises:
obtaining a shortest path from the target waypoint to the destination in a graph search algorithm;
calculating a driving time of the driverless vehicle from the target waypoint to the destination based on the shortest path and a preset driving speed;
obtaining the global cost from the target waypoint to the destination based on the driving time of the driverless vehicle from the target waypoint to the destination; and
utilizing the global cost from the target waypoint to the destination as the waypoint value of the target waypoint.

3. The route decision method according to claim 2, wherein the obtaining the global cost from the target waypoint to the destination based on the driving time of the driverless vehicle from the target waypoint to the destination comprises:
utilizing the driving time of the driverless vehicle from the target waypoint to the destination as the global cost from the target waypoint to the destination; or
calculating the global cost from the target waypoint to the destination based on target information from the target waypoint to the destination and the driving time of the driverless vehicle from the target waypoint to the destination.

4. The route decision method according to claim 1, wherein the performing the iteration to calculate the waypoint value of the waypoint between the target waypoint and the current position of the driverless vehicle based on the waypoint value of the target waypoint comprises:
calculating a waypoint value of a previous waypoint corresponding to the target waypoint by:
calculating a short-term cost and a state transition probability of transferring from the previous waypoint corresponding to the target waypoint to the target waypoint; and
superimposing the short-term cost of transferring from the previous waypoint corresponding to the target waypoint to the target waypoint, with the waypoint value of the target waypoint; and calculating the waypoint value of the previous waypoint corresponding to the target waypoint by combining a value of the short-term cost superimposing with the waypoint value of the target waypoint and the state transition probability.

5. The route decision method according to claim 1, wherein a plurality of target waypoints are provided between the current position of the driverless vehicle and the destination.

6. The route decision method according to claim 4, further comprising:
obtaining a special waypoint affected by traffic information when the driverless vehicle is driving according to the current route decision result;
in a case that the special waypoint is a waypoint to be reached according to the current route decision result, determining a next waypoint of the special waypoint according to the current route decision result, and updating a short-term cost from the special waypoint to the next waypoint;
updating the waypoint value of the special waypoint based on the updated short-term cost from the special waypoint to the next waypoint; and
performing a reverse iteration to update the waypoint value of the waypoint between the special waypoint and the current position of the driverless vehicle, according to the updated waypoint value of the special waypoint; and returning to the step of determining the action of the driverless vehicle at the current position based on the waypoint value of the next waypoint corresponding to the current position of the driverless vehicle in real time and obtaining the current route decision result for driving to the destination.

7. The route decision method according to claim 6, wherein the traffic information comprises a static traffic participant, and
the obtaining the special waypoint affected by the traffic information when the driverless vehicle is driving according to the current route decision result comprises:
determining the special waypoint affected by the static traffic participant based on a position of the static traffic participant, when the driverless vehicle is driving according to the current route decision result.

8. The route decision method according to claim 7, further comprising:
in a case that the special waypoint affected by the static traffic participant is a waypoint to be reached according to the current route decision result, and an adjacent lane of a lane where the special waypoint is located is impassable, dividing a lane line between the lane where the special waypoint affected by the static traffic participant is located and the adjacent lane into a plurality of waypoints connected in sequence; and
calculating the waypoint value of each waypoint on the lane line, based on the waypoint values of the waypoints on lanes adjacent to the lane line, the short-term costs and state transition probability of transferring between waypoints; and returning to the step of determining the action of the driverless vehicle at the current position based on the waypoint value of the next waypoint corresponding to the current position of the driverless vehicle in real time and obtaining the current route decision result for driving to the destination.

9. The route decision method according to claim 6, wherein the traffic information comprises dynamic traffic participants, and
the obtaining the special waypoint affected by the traffic information when the driverless vehicle is driving according to the current route decision result comprises:
determining a target dynamic traffic participant from the dynamic traffic participants, when the driverless vehicle is driving according to the current route decision result; and
determining a special waypoint affected by the target dynamic traffic participant, based on a driving speed of the target dynamic traffic participant and a driving speed of the driverless vehicle.

10. The route decision method according to claim 9, wherein the determining the target dynamic traffic participant from the dynamic traffic participants comprises:
determining a dynamic traffic participant within a preset range in front of the driverless vehicle as a potential target dynamic traffic participant;
determining whether a driving speed of the potential target dynamic traffic participant is less than a speed limit value of a lane where the potential target dynamic traffic participant is located, and obtaining a determination result;
calculating a confidence of the potential target dynamic traffic participant according to a value of the potential target dynamic traffic participant and the judgment result; and
determining the target dynamic traffic participant from the potential target dynamic traffic participant based on the confidence.

11. The route decision method according to claim 9, wherein in a case that the special waypoint is the waypoint to be reached according to the current route decision result, determining the next waypoint of the special waypoint according to the current route decision result, and updating the short-term cost from the special waypoint to the next waypoint comprises:
in a case that the special waypoint is the waypoint to be reached according to the current route decision result, determining the next waypoint of the special waypoint according to the current route decision result, and determining a driving distance from the special waypoint to the next waypoint; and
calculating the short-term cost of the driverless vehicle from the special waypoint to the next waypoint based on the driving distance and the driving speed of the target traffic participant, and obtaining the updated short-term cost from the special waypoint to the next waypoint.

12. The route decision method according to claim 6, wherein the state transition probability comprises a lane change success rate, and the method further comprises:
updating the lane change success rate of transferring between waypoints within the preset range of the driverless vehicle, based on the traffic information.

13. The route decision method according to claim 12, wherein the updating the lane change success rate of transferring between waypoints within the preset range of the driverless vehicle based on the traffic information comprises:
obtaining a current distance between a rear side vehicle of the driverless vehicle and the driverless vehicle and a current giving-way probability of the rear side vehicle of the driverless vehicle according to the traffic information, and updating the lane change success rate of the driverless vehicle at a current waypoint; and
updating a lane change success rate of a remaining waypoint within the preset range of the driverless vehicle according to a traffic density of a target change lane, wherein the target change lane is a lane after lane changing, and the remaining waypoint within the preset range of the driverless vehicle is a waypoint within the preset range of the driverless vehicle except the current waypoint where the driverless vehicle is located.

14. The route decision method according to claim 13, wherein the current giving-way probability of the rear side vehicle of the driverless vehicle is calculated by:
calculating the current giving-way probability of the rear side vehicle according to a current acceleration of the rear side vehicle of the driverless vehicle and a giving-way probability of the rear side vehicle at a previous moment, wherein an initial giving-way probability of the rear side vehicle is obtained through initialization.

15. (canceled)

16. A route decision device, comprising:
a processor and a memory,
wherein the memory is configured to store program codes and transmit the program codes to the processor;
the processor is configured to execute instructions in the program codes to:
divide a drivable road between a current position of an driverless vehicle and a destination into a plurality of waypoints, wherein the drivable road comprises at least one lane, and the lane comprises waypoints connected in sequence;
determine a target waypoint among the waypoints between the current position of the driverless vehicle and the destination, and calculate a global cost from the target waypoint to the destination to obtain a waypoint value of the target waypoint;
perform an iteration to calculate a waypoint value of a waypoint between the target waypoint and the current position of the driverless vehicle, according to the waypoint value of the target waypoint; and
determine an action of the driverless vehicle at the current position based on a waypoint value of a next waypoint corresponding to the current position of the driverless vehicle in real time, and obtain a current route decision result for driving to the destination.

17. A non-transitory computer readable storage medium, wherein the computer readable storage medium is configured to store program codes; and the program codes, when executed by a process, cause the processor to:
divide a drivable road between a current position of an driverless vehicle and a destination into a plurality of waypoints, wherein the drivable road comprises at least one lane, and the lane comprises waypoints connected in sequence;
determine a target waypoint among the waypoints between the current position of the driverless vehicle and the destination, and calculate a global cost from the target waypoint to the destination to obtain a waypoint value of the target waypoint;
perform an iteration to calculate a waypoint value of a waypoint between the target waypoint and the current position of the driverless vehicle, according to the waypoint value of the target waypoint; and
determine an action of the driverless vehicle at the current position based on a waypoint value of a next waypoint corresponding to the current position of the driverless vehicle in real time, and obtain a current route decision result for driving to the destination.

18. The route decision device according to claim 16, wherein the processor is configured to execute instructions in the program codes to:
obtain a shortest path from the target waypoint to the destination in a graph search algorithm;
calculate a driving time of the driverless vehicle from the target waypoint to the destination based on the shortest path and a preset driving speed;
obtain the global cost from the target waypoint to the destination based on the driving time of the driverless vehicle from the target waypoint to the destination; and
utilize the global cost from the target waypoint to the destination as the waypoint value of the target waypoint.

19. The route decision device according to claim 18, wherein the processor is configured to execute instructions in the program codes to:
utilize the driving time of the driverless vehicle from the target waypoint to the destination as the global cost from the target waypoint to the destination; or
calculate the global cost from the target waypoint to the destination based on target information from the target waypoint to the destination and the driving time of the driverless vehicle from the target waypoint to the destination.

20. The route decision device according to claim 16, wherein the processor is configured to execute instructions in the program codes to:
calculate a waypoint value of a previous waypoint corresponding to the target waypoint by:
calculating a short-term cost and a state transition probability of transferring from the previous waypoint corresponding to the target waypoint to the target waypoint; and
superimposing the short-term cost of transferring from the previous waypoint corresponding to the target waypoint to the target waypoint, with the waypoint value of the target waypoint; and calculating the waypoint value of the previous waypoint corresponding to the target waypoint by combining a value of the short-term cost superimposing with the waypoint value of the target waypoint and the state transition probability.

21. The route decision device according to claim 16, wherein the processor is configured to execute instructions in the program codes to:
obtain a special waypoint affected by traffic information when the driverless vehicle is driving according to the current route decision result;
in a case that the special waypoint is a waypoint to be reached according to the current route decision result, determine a next waypoint of the special waypoint according to the current route decision result, and update a short-term cost from the special waypoint to the next waypoint;
update the waypoint value of the special waypoint based on the updated short-term cost from the special waypoint to the next waypoint; and
perform a reverse iteration to update the waypoint value of the waypoint between the special waypoint and the current position of the driverless vehicle, according to the updated waypoint value of the special waypoint; and return to determine the action of the driverless vehicle at the current position based on the waypoint value of the next waypoint corresponding to the current position of the driverless vehicle in real time and obtaining the current route decision result for driving to the destination.
